(19) United States
(12) Patent Application Publication
(10) Pub. No.: US 2014/0177709 A1
(43) Pub. Date: Jun. 26, 2014

(54) IMAGE ENCODING APPARATUS, IMAGE ENCODING METHOD AND COMPUTER PROGRAM

(71) Applicant: CANON KABUSHIKI KAISHA, Tokyo (JP)

(72) Inventor: Hideaki Hattori, Kawasaki-shi (JP)

(73) Assignee: CANON KABUSHIKI KAISHA, Tokyo (JP)

(21) Appl. No.: 14/132,298

(22) Filed: Dec. 18, 2013

(30) Foreign Application Priority Data
Dec. 26, 2012 (JP) 2012-282823

(51) Int. Cl. H04N 19/593

(52) U.S. Cl. CPC H04N 19/00763
USPC 375/240.12

(57) ABSTRACT

To reduce power consumption in an encoding process without extremely lowering encoding efficiency, a chrominance of each pixel of a prediction block is derived as a reference chrominance block according to a chrominance intra prediction mode from a reference chrominance sample representing a chrominance of a pixel necessary for intra encoding, a difference between the reference chrominance block and a chrominance sample of an input encoding block is derived as a chrominance prediction residual, and an evaluation value of the chrominance prediction residual is derived. This process is performed to a candidate of the chrominance intra prediction mode adoptable irrespective of a luminance intra prediction mode. The chrominance intra prediction mode corresponding to the evaluation value when this evaluation value is equal to or smaller than a threshold is adopted as the chrominance intra prediction mode of the prediction block.

### BACKGROUND OF THE INVENTION

1. Field of the Invention

The present invention relates to an image encoding apparatus, an image encoding method, and a computer program for achieving the image encoding method. In particular, the present invention relates to a technique which is suitable for encoding an image using intra-screen prediction.

2. Description of the Related Art

As an encoding method for a compressed record of a moving picture (image), the H.264/MPEG-4 AVC (H.264/Moving Picture Experts Group-4 Advanced Video Coding: simply called the H.264 hereinafter) has been known.

Moreover, in recent years, an activity for achieving international standardization of a higher-efficiency encoding method has been started as the successor to the H.264. In this context, the JCT-VC (Joint Collaborative Team on Video Coding) has been established between the ISO/IEC (International Organization for Standardization/International Electrotechnical Commission) and the ITU-T (International Telecommunication Union Telecommunication Standardization Sector). In the JCT-VC, standardization of “High Efficiency Video Coding” (encoding method) has been developed (see “JCT-VC contributed article JCTVC-11003 d4.doc”<http://phenix.int-evry.fr/jct/doc_end_user/documens/9_Geneva/wg11/>: called the literature 1 hereinafter). In the following description, “High Efficiency Video Coding” (encoding method) will be called “HEVC” as needed.

In the HEVC, intra prediction encoding of performing intra-screen prediction using correlation of pixels in a screen (or an image plane) and encoding a prediction residual obtained by subtracting a prediction image from an input image has been adopted to improve encoding efficiency (see the chapter 8.4 of the literature 1). In the following description, “intra-screen prediction” will be called “intra prediction” as needed. Here, it should be noted that the intra prediction includes luminance intra prediction of performing the intra-screen prediction of a luminance component and chrominance intra prediction of performing the intra prediction of each of Cb and Cr chrominance components.

In the HEVC, any one of five kinds of sizes including 64×64 pixels, 32×32 pixels, 16×16 pixels, 8×8 pixels and 4×4 pixels can be selected as the size of a prediction block which is a unit of the intra prediction. In the following description, “size of prediction block” will be called “prediction block size” as needed. Incidentally, the 64×64 pixels correspond to the block which is constituted by the horizontal 64 pixels and the vertical 64 pixels, and this block will be called “64×64 pixels” as needed in the following description. Moreover, such expression is also applied to a block constituted by pixels of different number. Furthermore, the chrominance intra prediction block size which is a unit of the chrominance intra prediction can be selected from any one of four kinds of sizes including 32×32 pixels, 16×16 pixels, 8×8 pixels and 4×4 pixels, if an input format of the image is 4:2:0.

Moreover, in the HEVC, 35 modes have been defined respectively for each prediction block size as the intra prediction mode of a luminance component block (see the section 8.4.1 of the literature 1). In the following description, “intra prediction mode of luminance component block” will be called “luminance intra prediction mode” as needed.

In case of performing the intra prediction encoding using the HEVC, if the optimum luminance intra prediction mode is not selected from among the relevant 35 modes, a large prediction error occurs, whereby encoding efficiency is decreased.

Meanwhile, in the HEVC, the number of selectable modes for the intra prediction mode of a chrominance component block consisting of Cb and Cr components is limited as compared with the 35 modes for the luminance intra prediction mode. In the following description, “intra prediction mode of chrominance component block” will be called “chrominance intra prediction mode” as needed.

In the chrominance intra prediction mode in the HEVC, six modes of a DC mode, a planar mode, a horizontal mode, a vertical mode, a luminance reference mode, a mode 34 have been defined respectively for each prediction block size (see Table 8-3 in the section 8.4.2 of the literature 1). If the luminance intra prediction mode is any of the DC mode, the planar mode, the horizontal mode and the vertical mode, any of the DC mode, the planar mode, the horizontal mode, the vertical mode and the luminance reference mode can be selected as the chrominance intra prediction mode. Besides, if the luminance intra prediction mode is the mode other than the DC mode, the planar mode, the horizontal mode or the vertical mode, any of the DC mode, the planar mode, the horizontal mode, the vertical mode and the mode 34 can be selected as the chrominance intra prediction mode.

In case of determining the chrominance intra prediction mode for achieving high or sufficient encoding efficiency, it is necessary for the image encoding apparatus to respectively evaluate the five modes of the DC mode, the planar mode, the vertical mode, the horizontal mode and the luminance reference mode. The encoding efficiency at the time when the DC mode, the planar mode, the vertical mode or the horizontal mode is used does not depend on the luminance intra prediction mode. However, the encoding efficiency at the time when the luminance reference mode is used depends on the luminance intra prediction mode. For this reason, it is necessary for the image encoding apparatus to evaluate the chrominance intra prediction mode (the luminance reference mode) corresponding to each of the 35 luminance intra prediction modes. Here, in case of evaluating, in addition to the luminance intra prediction mode, the chrominance prediction mode for such many modes as the above 35 modes, there is a problem that power consumption of the image encoding apparatus increases. Such an increase in the power consumption is largely due to, in addition to the power to be consumed in each of the process block of searching the luminance intra prediction mode and the process block of searching the chrominance intra prediction mode, the power consumption of a clock tree connected to each process block.

Incidentally, as a method of easily determining the chrominance intra prediction mode, the method described in Japanese Patent Application Laid-Open No. 2010-251952 has been proposed. Namely, in Japanese Patent Application Laid-Open No. 2010-251952, the method of determining the chrominance intra prediction mode on the basis of a frequency of the luminance intra prediction mode determined in each prediction block within the encoding block has been proposed in fact.

However, if the chrominance intra prediction mode is determined without evaluating the chrominance components, the encoding efficiency of the chrominance components is seriously deteriorated.

The present invention has been completed in consideration of the above problem, and an object thereof is to reduce the power consumption necessary in the image encoding without seriously deteriorating the encoding efficiency.

### SUMMARY OF THE INVENTION

An image encoding apparatus according to the present invention is characterized by an image encoding apparatus which compresses an input image with respect to each encoding block and outputs an encoded stream, comprising: a first intra-screen prediction unit configured to, with respect to a plurality of candidates of a first prediction mode, derive a first prediction residual block which is a difference between a value of a first image component of a block obtained by performing intra-screen prediction to the first image component in the first prediction mode and a value of the first image component in a block obtained from the first image component of the input image, per a prediction block corresponding to the encoding block or a plurality of prediction blocks obtained by dividing the encoding block; a second intra-screen prediction unit configured to, with respect to a plurality of candidates of a second prediction mode, derive a second prediction residual block which is a difference between a value of a second image component of a block obtained by performing intra-screen prediction to the second image component in the second prediction mode and a value of the second image component in a block obtained from the second image component of the input image, per the prediction block corresponding to the encoding block or the plurality of prediction blocks obtained by dividing the encoding block; and a prediction mode determination unit configured to determine the second prediction mode to be used in the intra-screen prediction for the second image component of the input image, on the basis of an evaluation value representing an estimated generated code amount of the second prediction residual block obtained for the candidate of the second prediction mode, wherein, in a case where the evaluation value representing the estimated generated code amount of the second prediction residual block for the candidate of a specific second prediction mode among the candidates of the second prediction mode satisfies a predetermined condition, the prediction mode determination unit determines the candidate of the specific second prediction mode at a time when the evaluation value satisfying the predetermined condition is obtained, as the second prediction mode to be used in the intra-screen prediction for the second image component of the input image.

Further features of the present invention will become apparent from the following description of exemplary embodiments with reference to the attached drawings.

### BRIEF DESCRIPTION OF THE DRAWINGS

FIG. 1 is a block diagram illustrating a first example of the constitution of an image encoding apparatus.

FIGS. 2A and 2B are diagrams illustrating a reference luminance sample.

FIG. 3 is a block diagram illustrating the constitution of a luminance/chrominance integrated prediction mode decision unit.

FIG. 4 is a flow chart for describing a process of the image encoding apparatus.

FIG. 5 is a diagram illustrating a clock tree.

FIG. 6 is timing charts for describing on/off control of clocks.

FIG. 7 is a block diagram illustrating a second example of the constitution of the image encoding apparatus.

### DESCRIPTION OF THE EMBODIMENTS

Subsequently, preferred embodiments of the present invention will now be described in detail in accordance with the accompanying drawings.

### First Embodiment

First, the first embodiment of the present invention will be described.

In the present embodiment, it is assumed that one or more input images are divided into encoding blocks each having 32×32 pixels and encoding is performed with respect to each of the encoding blocks. Namely, in the present embodiment, it is assumed that the size of the encoding block which is the target block of the encoding is equivalent to 32×32 pixels. Moreover, in the present embodiment, only an “I slice” in which encoding is performed using intra prediction (luminance intra prediction and chrominance intra prediction) is the encoding target but “P slice and B slice” in which encoding is performed using inter-screen prediction with motion vectors are not the encoding target.

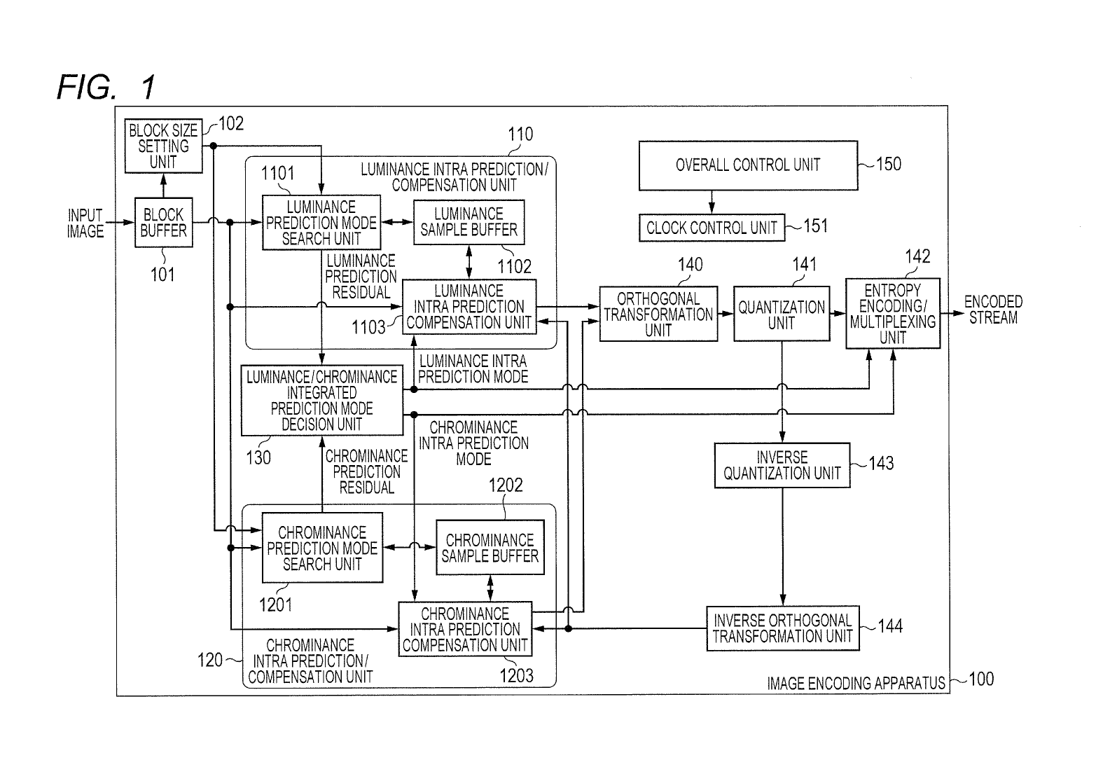

Hereinafter, an example of an operation to be performed by an image encoding apparatus according to the present embodiment will be described with reference to FIG. 1. Namely, FIG. 1 is the block diagram illustrating an example of the constitution of an image encoding apparatus 100. Here, it should be noted that the image encoding apparatus 100 compresses an input image, generates an encoded stream based on the compressed image, and outputs the generated encoded stream.

In FIG. 1, an overall control unit 150 performs, for example, control of each process block in the image encoding apparatus 100 and transfer of parameters among respective process blocks. A clock control unit 151 controls start (on)/stop (off) of a clock to be supplied to each process block in the image encoding apparatus 100, in response to an instruction transferred from the overall control unit 150. Incidentally, it is assumed in the present embodiment that the clock to be supplied to each of the overall control unit 150 and the clock control unit 151 is always on.

When it is instructed from the overall control unit 150 to start the clock supply to each process block, the clock control unit 151 transfers the clock to each process block while keeping the externally input clock frequency. On the other hand, when it is instructed from the overall control unit 150 to stop the clock supply to each process block, the clock control unit 151 does not transfer the externally input clock to each process block, whereby the clock frequency between the clock control unit 151 and each process block is “0” (that is, the value of the clock does not change).

Incidentally, it should be noted that wire connections between the set of the overall control unit 150 and the clock control unit 151 and each process block are omitted in FIG. 1.

The overall control unit 150 can control each process block in the image encoding apparatus 100 and read/write parameters among the respective process blocks, through parameter signal lines or register buses. Here, the “on/off-controlled clock” output from the clock control unit 151 serves as the clock for each process block. Moreover, in the present embodiment, although the overall control unit 150 and the clock control unit 151 both illustrated in FIG. 1 are disposed in the image encoding apparatus 100, these units may not be necessarily disposed in the image encoding apparatus. In other words, the overall control unit 150 and the clock control unit 151 may be disposed outside the image encoding apparatus 100.

A block buffer 101 records therein a luminance sample and a chrominance sample of one or a plurality of encoding blocks in an input one or more images (input images). Here, it should be noted that the luminance sample is obtained by giving a luminance component (a value of luminance) of “each pixel of the input image” corresponding to the encoding block to each pixel of the encoding block, and the chrominance sample is obtained by giving a chrominance component (a value of chrominance) of each of Cb and Cr of “each pixel of the input image” corresponding to the encoding block to each pixel of the encoding block.

A block size setting unit 102 reads the encoding block from the one or the plurality of encoding blocks recorded by the block buffer 101, with respect to each encoding block. Then, the block size setting unit 102 sets a predetermined prediction block size and a conversion block size to the read encoding block. In the present embodiment, it is assumed that the prediction block size of the luminance component is 16×16 pixels, and the prediction block size of the chrominance component is 8×8 pixels. Moreover, in the present embodiment, it is assumed that a format of the input image (i.e., an input format) is 4:2:0.

Incidentally, in case of performing the encoding by using the HEVC, the block size setting unit 102 can use any one of the following sizes as the prediction block size. That is, the block size setting unit 102 can use any one of the four kinds of sizes of 32×32 pixels, 16×16 pixels, 8×8 pixels and 4×4 pixels, as the prediction block size. In the present embodiment, the encoding block size is 32×32 pixels. For this reason, in case of performing the encoding by using the HEVC, it is possible to use the size equal to or smaller than 32×32 pixels which is the encoding block size, among the prediction block sizes which are usable in the HEVC. Moreover, the block size setting unit 102 can use, as the conversion block size, any one (the size equal to or smaller than the prediction block size) of the sizes of 4×4 pixels, 8×8 pixels, 16×16 pixels and 32×32 pixels which are equal to or smaller than the prediction block size.

Moreover, in the present embodiment, the block size setting unit 102 previously determines the prediction block size on the basis of the result obtained by analyzing the data of the encoding block. However, it is not necessary to perform such previous determination at all times. That is, it is possible for the block size setting unit 102 to respectively operate a luminance intra prediction/compensation unit 110 and a chrominance intra prediction/compensation unit 120 for all of the usable prediction block sizes and search for an optimum prediction block size on the basis of the results of the above operations. Moreover, it is possible for the block size setting unit 102 to read “a prediction block size and a conversion block size” previously determined within and outside the image encoding apparatus 100 of the present embodiment and respectively set the read sizes. Moreover, it is possible as an algorithm for determining the prediction block size to apply any existing algorithm without depending on a specific algorithm.

The luminance intra prediction/compensation unit 110 reads “the luminance sample of the encoding block” recoded in the block buffer 101. Further, the luminance intra prediction/compensation unit 110 reads “the prediction block size of the luminance component (i.e., a first image component)” set by the block size setting unit 102. Furthermore, the luminance intra prediction/compensation unit 110 searches for a luminance intra prediction mode (i.e., a first prediction mode) from among a plurality of candidates of the luminance intra prediction mode. The chrominance intra prediction/compensation unit 120 reads “the chrominance sample of the encoding block” recoded in the block buffer 101. Further, the chrominance intra prediction/compensation unit 120 reads “the prediction block size of the chrominance component” set by the block size setting unit 102. Furthermore, the chrominance intra prediction/compensation unit 120 searches for a chrominance intra prediction mode (i.e., a second prediction mode) from among a plurality of candidates of the chrominance intra prediction mode.

In the following description, “the candidate of the luminance intra prediction mode” and “the candidate of the chrominance intra prediction mode” will be respectively called “the luminance prediction mode candidate” and “the chrominance prediction mode candidate”, as needed. Incidentally, in case of performing the encoding by using the HEVC, the 35 modes have been defined as the luminance prediction mode candidates. Moreover, as the chrominance prediction mode candidates, six modes of a DC mode, a planar mode, a horizontal mode, a vertical mode, a luminance reference mode and a mode 34 have been defined based on the luminance intra prediction modes.

Hereinafter, an example of the operations of the constituent elements in the luminance intra prediction/compensation unit 110 will be described. A luminance prediction mode search unit 1101 (i.e., a first intra-screen prediction unit) is the process unit which performs generation of a reference luminance block and calculation of a luminance prediction residual block respectively, in correspondence with each luminance prediction mode candidate. Incidentally, an algorithm for searching for the luminance intra prediction mode used in the encoding from the luminance intra prediction mode candidates will be described later.

Initially, the luminance prediction mode search unit 1101 inputs a reference luminance sample which has been recorded in a luminance sample buffer 1102 and is necessary for the intra prediction.

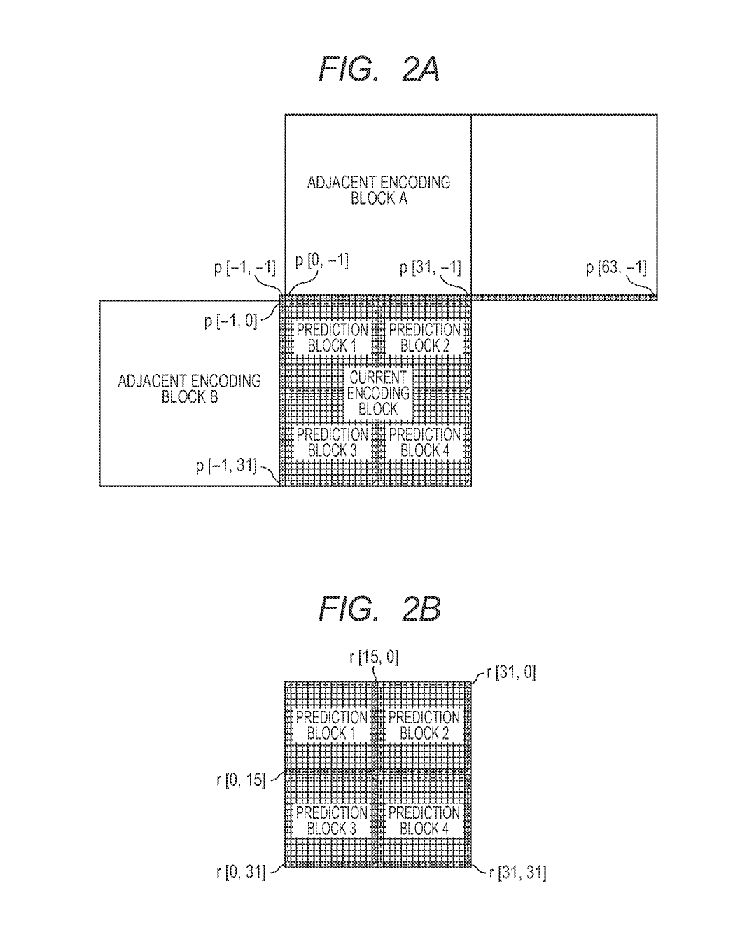

Then, an example of “the reference luminance sample which is necessary for the intra prediction” recorded in the luminance sample buffer 1102 are illustrated in FIGS. 2A and 2B. Incidentally, the reference luminance sample is based on luminance pixels reconstituted by a luminance intra prediction compensation unit 1103. The detail of the process to be performed by the luminance intra prediction compensation unit 1103 will be described later.

In a case where the encoding block size of the encoding block is 32×32 pixels, the following reconstituted luminance pixels in an encoding block (i.e., an adjacent encoding block) adjacent to the encoding block are necessary in case of generating the reference luminance sample (FIG. 2A).
the lower-end 64 pixels (p[0, −1] to p[63, −1]) of the adjacent encoding block being adjacent at the upper side and the oblique upper right side of the encoding block
the right-end 32 pixels (p[−1, 0] to p[−1, 31]) of the adjacent encoding block being adjacent at the left side of the encoding block
the one pixel (p[−1, −1]) at the oblique upper left side of the encoding block

Moreover, in a case where the prediction block size of the encoding block is 16×16 pixels, the reconstituted luminance pixels in the same encoding block are necessary in case of generating the reference luminance sample (FIG. 2B). More specifically, FIG. 2B shows “the reconstituted luminance pixels” in which the hatching pixels (the 124 pixels in all) are used as the reference luminance sample in the encoding block.

As just described, the luminance prediction mode search unit 1101 inputs, from the luminance sample buffer 1102, the reconstituted luminance pixels in the adjacent encoding block and the reconstituted luminance pixels in the encoding block, as the reference luminance sample.

The chrominance intra prediction/compensation unit 120 performs the same operation as that the luminance intra prediction/compensation unit 110 performs.

A chrominance prediction mode search unit 1201 (i.e., a second intra-screen prediction unit) performs generation of a reference chrominance block and calculation of a chrominance prediction residual block respectively, in correspondence with each chrominance prediction mode candidate. Although FIGS. 2A and 2B illustrate only the reference luminance sample being the reference sample of the luminance component, also a reference chrominance sample being the reference sample of the chrominance component (i.e., a second image component) can be expressed in the same manner as illustrated in FIGS. 2A and 2B. The chrominance prediction mode search unit 1201 inputs, from a chrominance sample buffer 1202, the reconstituted chrominance pixels in the adjacent encoding block and the reconstituted chrominance pixels in the encoding block, as the reference chrominance sample.

Hereinafter, an example of algorithms of the luminance prediction mode search unit 1101 and the chrominance prediction mode search unit 1201 respectively searching for the luminance intra prediction mode and the chrominance intra prediction mode used in the encoding in correspondence with each luminance prediction mode candidate and each chrominance intra prediction mode candidate will be described.

The luminance prediction mode search unit 1101 reads, from the luminance sample buffer 1102, the reference luminance sample to be used in the luminance prediction mode (i.e., a luminance search target mode) being the search target among the luminance prediction mode candidates, and generates the reference luminance block. Here, it should be noted that the reference luminance block is obtained by giving “the luminance component (the value of luminance) of each pixel of the prediction block” generated from the reference luminance sample in correspondence with the luminance intra prediction mode to each pixel corresponding to the luminance component of each pixel of the prediction block.

Likewise, the chrominance prediction mode search unit 1201 reads, from the chrominance sample buffer 1202, the reference chrominance sample to be used in the chrominance prediction mode (i.e., a chrominance search target mode) being the search target among the chrominance prediction mode candidates, and generates the reference chrominance block. Here, it should be noted that the reference chrominance block is obtained by giving “the respective chrominance components (the values of chrominance) of Cb and Cr of each pixel of the prediction block” generated from the reference chrominance sample in correspondence with the chrominance intra prediction mode to each pixel corresponding to the prediction block. Incidentally, the reference luminance block and the reference chrominance block have been described as predSample[x, y] in the literature 1. Namely, since the generation algorithm of “the reference luminance block and the reference chrominance block” corresponding to each of the 35 intra prediction modes has been described in the section 8.4.3.1 of the literature 1, the detailed description thereof will be omitted.

Subsequently, the luminance prediction mode search unit 1101 calculates a difference between the reference luminance block for each prediction block in the encoding block and the luminance sample of the encoding block input from the block buffer 101, and generates a luminance prediction residual block (i.e., a first prediction residual block). Likewise, the chrominance prediction mode search unit 1201 calculates a difference between the reference chrominance block for each prediction block in the encoding block and the chrominance sample of the encoding block input from the block buffer 101, and generates a chrominance prediction residual block (i.e., a second prediction residual block). Incidentally, in the present embodiment, the luminance prediction residual block is constituted by 16×16 pixels, and the chrominance prediction residual block is constituted by 8×8 pixels for each of the Cr and Cb components.

As described above, in the present embodiment, the luminance prediction mode search unit 1101 uses “the reconstituted luminance pixel” recorded in the luminance sample buffer 1102 as the reference luminance sample. Likewise, in the present embodiment, the chrominance prediction mode search unit 1201 uses “the reconstituted chrominance pixel” recorded in the chrominance sample buffer 1202 as the reference chrominance sample. However, the present invention is not limited to such operations. That is, the luminance prediction mode search unit 1101 and the chrominance prediction mode search unit 1201 can search for each intra prediction mode by using “the luminance sample and the chrominance sample of the encoding block” recorded in the block buffer 101 so as to achieve high-speed process.

The luminance prediction mode search unit 1101 transfers the generated luminance prediction residual block of 16×16 pixels to a luminance/chrominance integrated prediction mode decision unit 130. Likewise, the chrominance prediction mode search unit 1201 transfers “the chrominance prediction residual block of 8×8 pixels” generated for each of the Cb and Cr components to the luminance/chrominance integrated prediction mode decision unit 130.

The luminance/chrominance integrated prediction mode decision unit 130 (i.e., a prediction mode determination unit) receives the luminance prediction residual block corresponding to the luminance intra prediction mode and the chrominance prediction residual block corresponding to the chrominance prediction mode, respectively. Moreover, the luminance/chrominance integrated prediction mode decision unit 130 calculates an evaluation value representing an estimated generated code amount of the corresponding prediction residual block for each of the luminance prediction mode candidate and the chrominance prediction mode candidate. Then, the luminance/chrominance integrated prediction mode decision unit 130 respectively determines “the luminance intra prediction mode and the chrominance intra prediction mode” to be used in the encoding, on the basis of the calculated evaluation values. Incidentally, the details of methods of determining the luminance intra prediction mode and the chrominance intra prediction mode will be described later.

The luminance intra prediction compensation unit 1103 generates the luminance prediction residual block corresponding to the luminance intra prediction mode determined by the luminance/chrominance integrated prediction mode decision unit 130, and outputs the generated luminance prediction residual block to an orthogonal transformation unit 140. Likewise, a chrominance intra prediction compensation unit 1203 generates the chrominance prediction residual block corresponding to the chrominance intra prediction mode determined by the luminance/chrominance integrated prediction mode decision unit 130, and outputs the generated chrominance prediction residual block to the orthogonal transformation unit 140.

As just described, the luminance prediction residual block is input from the luminance intra prediction compensation unit 1103 to the orthogonal transformation unit 140. Hereinafter, examples of the respective processes to be performed in this case by the orthogonal transformation unit 140, a quantization unit 141, an entropy encoding/multiplexing unit 142, an inverse quantization unit 143 and an inverse orthogonal transformation unit 144 will be described.

The orthogonal transformation unit 140 performs orthogonal transformation to the luminance prediction residual block generated by the luminance intra prediction compensation unit 1103 with respect to each conversion block set by the block size setting unit 102, thereby generating an orthogonal transformation coefficient. Moreover, the orthogonal transformation unit 140 outputs the generated orthogonal transformation coefficient to the quantization unit 141. Incidentally, in the HEVC, the sizes of 32×32 pixels, 16×16 pixels, 8×8 pixels and 4×4 pixels have been defined as the usable conversion block sizes. Moreover, in the present embodiment, the block size setting unit 102 uses the encoding block size of 32×32 pixels. In other words, in case of performing the encoding by using the HEVC, the block size setting unit 102 can use the size equal to or smaller than 32×32 pixels (i.e., any one of 32×32 pixels to 4×4 pixels) being the encoding block size, among the conversion block sizes usable in the HEVC.

The quantization unit 141 performs quantization of the orthogonal transformation coefficient input from the orthogonal transformation unit 140, on the basis of the quantization parameter input from the overall control unit 150, and then transfers the quantized orthogonal transformation coefficient to the entropy encoding/multiplexing unit 142.

The entropy encoding/multiplexing unit 142 performs entropy encoding of the orthogonal transformation coefficient quantized by the quantization unit 141. Moreover, the entropy encoding/multiplexing unit 142 performs entropy encoding of the header information of the luminance intra prediction mode or the like determined by the luminance/chrominance integrated prediction mode decision unit 130. Then, the entropy encoding/multiplexing unit 142 multiplexes the entropy-encoded orthogonal transformation coefficient and the entropy-encoded header information together, and then outputs the multiplexed data to the outside of the image encoding apparatus 100 as the encoded stream.

The inverse quantization unit 143 performs inverse quantization to the orthogonal transformation coefficient quantized by the quantization unit 141.

The inverse orthogonal transformation unit 144 performs inverse orthogonal transformation to the orthogonal transformation coefficient subjected the inverse quantization by the inverse quantization unit 143, with respect to each conversion block size same as that used in the process by the orthogonal transformation unit 140. Moreover, the inverse orthogonal transformation unit 144 decodes the orthogonal transformation coefficient subjected to the inverse orthogonal transformation, and thus generates the luminance prediction residual block. Then, the inverse orthogonal transformation unit 144 transfers the generated luminance prediction residual block to the luminance intra prediction compensation unit 1103.

In the present embodiment, the processes to be performed by the respective units 140 to 144 to the luminance prediction residual block have been described. Here, it should be noted that the respective units 140 to 144 perform the similar processes also to the chrominance prediction residual block. That is, when the chrominance prediction residual block is input from the chrominance intra prediction compensation unit 1203 to the orthogonal transformation unit 140, the respective units 140 to 144 perform the orthogonal transformation, the quantization, the entropy encoding, the multiplexing, the inverse quantization and the inverse orthogonal transformation to the input chrominance prediction residual block, as well as the processes to be performed to the luminance prediction residual block. Then, the inverse orthogonal transformation unit 144 transfers the generated chrominance prediction residual block to the chrominance intra prediction compensation unit 1203.

The luminance intra prediction compensation unit 1103 adds the luminance prediction residual block generated by the inverse orthogonal transformation unit 144 and the reference luminance block used when generating the luminance prediction residual block to each other, and thus generates a reconstituted luminance block consisting of a reconstituted luminance sample. Moreover, the luminance intra prediction compensation unit 1103 records the right-end pixels (r[15, 0] to r[15, 15]) and the lower-end pixels (r[0, 15] to r[14, 15]) of the reconstituted luminance block to the luminance sample buffer 1102 as the reconstituted reference luminance sample. Likewise, the chrominance intra prediction compensation unit 1203 adds the chrominance prediction residual block generated by the inverse orthogonal transformation unit 144 and the reference chrominance block used when generating the chrominance prediction residual block to each other, and thus generates a reconstituted chrominance block consisting of a reconstituted chrominance sample. Moreover, the chrominance intra prediction compensation unit 1203 records the right-end pixels and the lower-end pixels of the reconstituted chrominance block to the chrominance sample buffer 1202 as the reconstituted reference chrominance sample.

Subsequently, examples of algorithms for searching for the intra prediction modes in the luminance prediction mode search unit 1101 and the chrominance prediction mode search unit 1201, and an example of an algorithm for determining the intra prediction modes in the luminance/chrominance integrated prediction mode decision unit 130 will be described hereinafter.

In the present embodiment, the luminance prediction mode search unit 1101 and the chrominance prediction mode search unit 1201 respectively search for the luminance intra prediction mode and the chrominance intra prediction mode in the following order. Here, it should be noted that the description is based on the names and the symbols described in the section 8.4.1 of the literature 1.

#0: Intra_Planar (mode 0, planar mode)
#1: Intra_DC (mode 1, DC mode)
#2: Angular_{—}10 (mode 10, horizontal mode)
#3: Angular_{—}26 (mode 26, vertical mode)
#4: Angular_{—}2 (mode 2)
#5: Angular_{—}3 (mode 3)
[symbol] (mode 4 to mode 34 other than modes 10, 26)
[symbol] #34: Angular_{—}34 (mode 34)

The luminance/chrominance integrated prediction mode decision unit 130 calculates an evaluation value IStotal[i] from following Equation 1, on the basis of the luminance prediction residual block generated by the luminance prediction mode search unit 1101 and the chrominance prediction residual block generated by the chrominance prediction mode search unit 1201. Incidentally, it should be noted that the luminance/chrominance integrated prediction mode decision unit 130 calculates the evaluation value IStotal[i] for each intra prediction mode candidate (i.e., each luminance prediction mode candidate and each chrominance prediction mode candidate).

IStotal[i]=(Wy[i]×ISy[i])+(Wcb[i]×IScb[i])+(Wcr[i]×IScr[i]) Equation 1

where i=0, 1, . . . , 34

In the Equation 1, the symbol “i” indicates the candidate of the intra prediction mode which is the search target, and corresponds to the above #0 to #34.

The luminance evaluation value ISy[i], the chrominance evaluation value IScb[i] and the chrominance evaluation value IScr[i] are the evaluation values which respectively represent the estimated generated code amounts of the luminance prediction residual block, the Cb-component chrominance prediction residual block and the Cr-component chrominance prediction residual block. In the present embodiment, SAD (sum of absolute difference) which is obtained by summing the absolute-value prediction residuals in the prediction residual block is used as the evaluation value. Moreover, in the Equation 1, the symbol Wy[i] indicates a weight of the luminance component, the symbol Wcb[i] indicates a weight of the Cb component of the chrominance, and the symbol Wcr[i] indicates a weight of the Cr component of the chrominance.

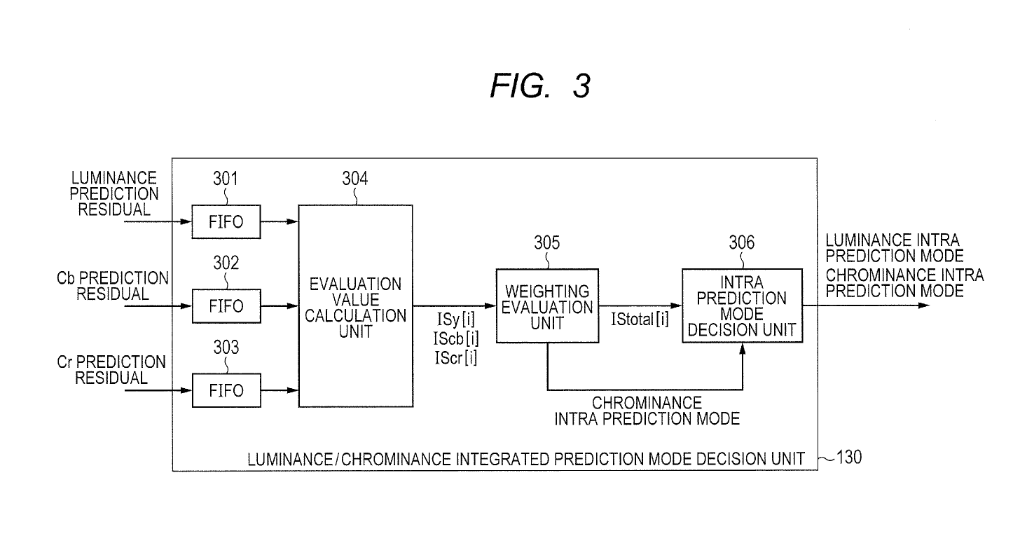

Subsequently, an example of the constitution of the luminance/chrominance integrated prediction mode decision unit 130 for achieving the calculation of the Equation 1 is illustrated in FIG. 3. As illustrated in FIG. 3, the luminance/chrominance integrated prediction mode decision unit 130 includes FIFOs (first-in first-out memories) 301 to 303, an evaluation value calculation unit 304, a weighting evaluation unit 305 and an intra prediction mode decision unit 306.

The FIFO 301 stores therein the luminance prediction residual block input from the luminance prediction mode search unit 1101. Likewise, the FIFO 302 and the FIFO 303 respectively store the chrominance residual blocks (the Cb-component chrominance prediction residual block and the Cr-component chrominance prediction residual block) respectively input from the chrominance prediction mode search unit 1201. In general, the time when the prediction residual block for luminance (Y) is generated is different from the time when the prediction residual blocks for chrominances (Cb, Cr) are generated. For this reason, it is possible to achieve synchronization for these blocks by once storing the respective prediction residual blocks in the FIFOs 301 to 303 and then properly transferring them to the evaluation value calculation unit 304.

Then, the luminance prediction residual block, the Cb-component chrominance prediction residual block and the Cr-component chrominance prediction residual block are input from the respective FIFOs 301 to 303 to the evaluation value calculation unit 304. Then, the evaluation value calculation unit 304 calculates the evaluation value ISy[i] for the input luminance prediction residual block, the evaluation value IScb[i] for the input Cb-component chrominance prediction residual block and the evaluation value IScr[i] for the input Cr-component chrominance prediction residual block. Incidentally, if the evaluation value calculation unit 304 respectively calculates the luminance evaluation value ISy[i] and the chrominance evaluation values IScb[i] and IScr[i] at different times, then the evaluation value calculation unit 304 can be shared among the luminance and the chrominance.

The weighting evaluation unit 305 calculates the evaluation value IStotal[i] by weighting (multiplying) the respective evaluation values ISy[i], IScb[i] and IScr[i] with the respective weights Wy[i], Wcb[i] and Wcr[i] and adding them together. Here, it should be noted that the evaluation value IStotal[i] is calculated for each of the intra prediction mode candidates (each luminance prediction mode candidate, and each chrominance prediction mode candidate).

Subsequently, the evaluation value IStotal[i] for each intra prediction mode candidate is input from the weighting evaluation unit 305 and then stored in the intra prediction mode decision unit 306. Among all the intra prediction mode candidates, the mode for which the evaluation value IStotal[i] is minimum is set as the optimum intra prediction mode, thereby determining the luminance intra prediction mode and the chrominance intra prediction mode. Incidentally, as described later, the intra prediction mode decision unit 306 can output the chrominance intra prediction mode determined by the weighting evaluation unit 305.

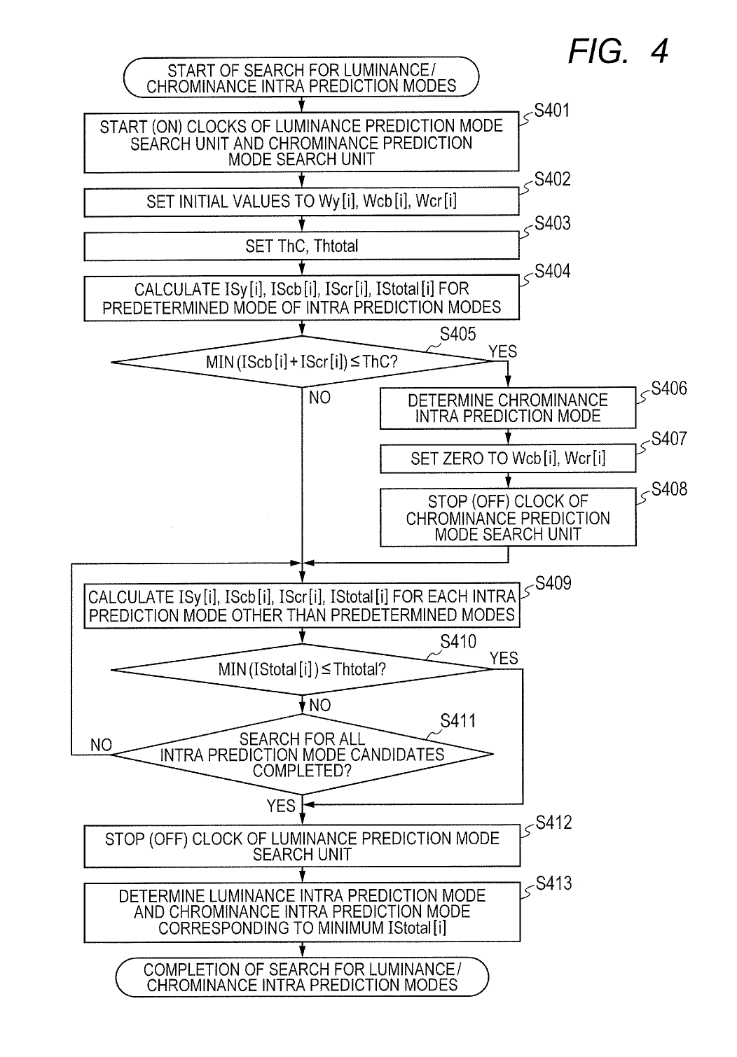

Hereinafter, an example of a method by the overall control unit 150 for controlling clock start/stop using the clock control unit 151 and an example of a method by the intra prediction mode decision unit 306 for determining the luminance intra prediction mode and the chrominance intra prediction mode will be described with reference to a flow chart illustrated in FIG. 4. Concurrently, also a method by the weighting evaluation unit 305 for determining the respective weights Wy[i], Wcb[i] and Wcr[i] will be described with reference to the flow chart illustrated in FIG. 4.

In a step S401, the overall control unit 150 controls the clock control unit 151 to start (on) the clocks to be supplied to the luminance prediction mode search unit 1101 and the luminance sample buffer 1102, in order to start searching for the luminance intra prediction mode. Likewise, the overall control unit controls the clock control unit 151 to start (on) the clocks to be supplied to the chrominance prediction mode search unit 1201 and the chrominance sample buffer 1202, in order to start searching for the chrominance intra prediction mode.

Next, in a step S402, the weighting evaluation unit 305 sets an initial value to each of the weights Wy[i], Wcb[i] and Wcr[i]. Incidentally, it is assumed in the present embodiment that the initial value of each of the weights Wy[i], Wcb[i] and Wcr[i] is based on a ratio between the quantization parameter of the luminance component and the quantization parameter of the chrominance component, as indicated by following Equations 2 to 4.

Wy[i]=1 Equation 2

Wcb[i]=αcb×qp_luma/(qp_luma+qp_{—}cb_offset). Equation 3

Wcr[i]=αcr×qp_luma/(qp_luma+qp_{—}cr_offset). Equation 4

Hereinafter, the parameters shown in the Equations 3 and 4 will be described.

First, the symbol qp_luma indicates the quantization parameter of the luminance component of the encoding block. The symbols qp_cb_offset and qp_cr_offset respectively indicate quantization parameter offsets of the chrominance component (i.e., the Cb component and the Cr component), and each of these parameters indicates an offset (a difference value) from the quantization parameter of the luminance component. Furthermore, each of the symbols αcb and αcr indicates a user setting parameter to which the user of the image encoding apparatus 100 can set an arbitrary value. The user can properly customize the user setting parameters according to contents and uses of the images. Incidentally, the user can adjust encoding results by inputting the user setting parameters αcb and αcr based on, e.g., target code amounts and header-information code amounts through the operations to the image encoding apparatus 100. Moreover, it should be noted that the initial values of the respective weights Wy[i], Wcb[i] and Wcr[i] and the respective user setting parameters αcb and αcr shown in the Equations 2 to 4 are set to the weighting evaluation unit 305 by the overall control unit 150 illustrated in FIG. 1.

Next, in a step S403, the weighting evaluation unit 305 sets a threshold value ThC for determining the later-described chrominance intra prediction to any one of the planar mode, the DC mode, the horizontal mode and the vertical mode, based on the user's operation to the image encoding apparatus 100. Moreover, in the step S403, the weighting evaluation unit 305 sets a threshold value Thtotal[i] for the evaluation value IStotal[i] on the basis of a user's operation to the image encoding apparatus 100.

Next, in a step S404, the weighting evaluation unit 305 performs such an operation as described below. That is, the weighting evaluation unit 305 calculates the evaluation values ISy[i], IScb[i], IScr[i] and IStotal[i] respectively corresponding to each predetermine mode in a case where the luminance intra prediction mode and the chrominance intra prediction mode are predetermined modes. Incidentally, in the present embodiment, the predetermined modes are the planar mode (#0), the DC mode (#1), the horizontal mode (#2) and the vertical mode (#3). It should be noted that these modes #0 to #3 are the mode which can be used in the chrominance intra prediction even if what mode is used as the luminance intra prediction mode. That is, encoding efficiency in case of using the predetermined modes #0 to #3 does not depend on the luminance intra prediction mode. In the step S404, the evaluation value IStotal[i] is calculated for each of the predetermined modes #0 to #3.

Next, in a step S405, the weighting evaluation unit 305 calculates the minimum value of a chrominance component evaluation value (=IScb[i]+IScr[i]) in each predetermined mode calculated in the step S404. Then, the weighting evaluation unit 305 compares the calculated minimum value and the threshold value ThC set in the step S403 with each other to determine whether or not the calculated minimum value is equal to or smaller than the threshold value ThC. Then, if it is determined that the calculated minimum value is equal to or smaller than the threshold value ThC, the flow advances to a step S406. On the other hand, if it is determined that the calculated minimum value is larger than the threshold value ThC, the flow advances to a step S409.

When it is determined in the step S405 as YES (that is, the minimum value of the chrominance component evaluation value (=IScb[i]+IScr[i]) is equal to or smaller than the threshold value ThC), the weighting evaluation unit 305 performs the process in the step S406. In this case, since the chrominance component evaluation value (=IScb[i]+IScr[i]) is sufficiently small, it is determined that sufficient encoding efficiency can be achieved by the chrominance intra prediction mode corresponding to the chrominance component evaluation value being the minimum value. Consequently, the weighting evaluation unit 305 determines the chrominance intra prediction mode corresponding to the chrominance component evaluation value being the minimum value as the chrominance intra prediction mode to be used when generating the encoded stream, and transfers the determined chrominance intra prediction mode to the intra prediction mode decision unit 306.

Next, in a step S407, the overall control unit 150 sets the value of each of the weights Wcb[i] and Wcr[i] of the chrominance components to be used by the weighting evaluation unit 305 to zero. The chrominance intra prediction mode determined in the step S406 can be selected even when any mode is used as the luminance intra prediction mode. Consequently, it is possible, by setting the value of each of the weights Wcb[i] and Wcr[i] of the chrominance components to zero, to search for the luminance intra prediction mode of optimum encoding efficiency in consideration of only the luminance component. For this reason, it is possible to prevent that the searching of the luminance intra prediction mode is redundantly influenced by the encoding efficiency of the chrominance components. Moreover, in the step S407, the overall control unit 150 changes the evaluation values IStotal[i] corresponding to the predetermined modes #0 to #3 calculated in the step S404 to the evaluation value IStotal[i]=ISy[i]. Thus, it is possible to reflect the fact that each of the weights Wcb[i] and Wcr[i] of the chrominance components has been changed to zero.

Next, in a step S408, the overall control unit 150 controls the clock control unit 151 to stop (off) the clocks to be supplied to the chrominance prediction mode search unit 1201 and the chrominance sample buffer 1202.

In the step S409, the weighting evaluation unit 305 respectively calculates the evaluation values ISy[i], IScb[i], IScr[i] and IStotal[i] corresponding to each of the respective modes #4 to #34 other than the predetermined modes #0 to #3.

Next, in a step S410, the weighting evaluation unit 305 determines whether or not the evaluation value IStotal[i] corresponding to the modes #4 to #34 calculated in the step S409 is equal to or smaller than the threshold value Thtotal set in the step S403. Then, if it is determined that the evaluation value is equal to or smaller than the threshold value Thtotal (YES in the step S410), the process advances to a step S412, thereby omitting to evaluate other luminance and chrominance intra prediction modes. On the other hand, if it is determined that the relevant evaluation value exceeds the threshold value Thtotal (NO in the step S410), the process advances to a step S411 to evaluate other intra prediction mode candidates.

In the step S411, the weighting evaluation unit 305 determines whether or not all the candidates of the luminance and chrominance intra prediction modes have been searched. Then, if it is determined that all the candidates have been searched (YES in the step S411), the searching of the intra prediction mode is completed, and the flow advances to the step S412. On the other hand, if it is determined that all the candidates are not yet searched (NO in the step S411), the flow returns to the step S409 to evaluate other intra prediction mode candidates.

In the step S412, the overall control unit 150 controls the clock control unit 151 to stop (off) the clocks to be supplied to the luminance prediction mode search unit 1101 and the luminance sample buffer 1102.

Next, in a step S413, the intra prediction mode decision unit 306 determines the mode corresponding to the evaluation value IStotal[i] having the minimum value, as the luminance intra prediction mode, from among the respective modes #0 to #34 being the luminance prediction mode candidates. Moreover, in the step S413, the intra prediction mode decision unit 306 outputs the chrominance intra prediction mode determined in the step S406, when YES is obtained in the step S405 (i.e., the minimum value of the chrominance component evaluation value (IScb[i]+IScr[i]) is equal to or smaller than the threshold value ThC). On the other hand, the intra prediction mode decision unit determines the chrominance intra prediction mode as the luminance reference mode, when NO is obtained in the step S405 (i.e., the minimum value of the chrominance component evaluation value (IScb[i]+IScr[i]) exceeds the threshold value ThC). That is, in this case (NO in the step S405), the intra prediction mode decision unit 306 determines the mode same as the luminance intra prediction mode determined in the step S413, as the chrominance intra prediction mode.

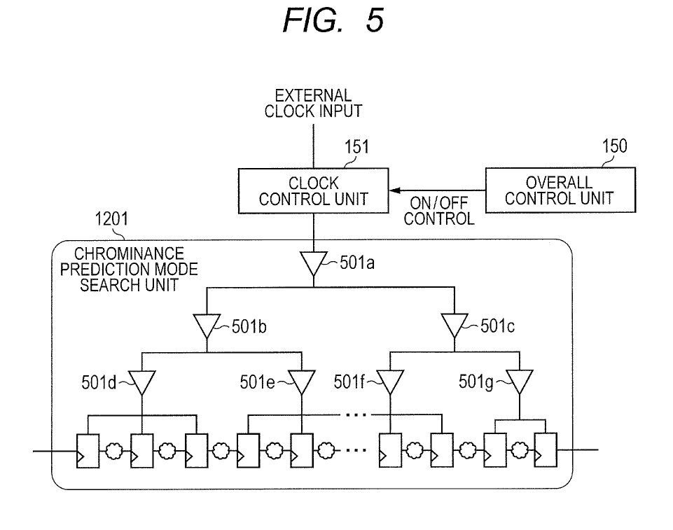

As described above, it is possible, by stopping (off) the clock with use of the clock control unit 151, to reduce power consumed in a clock tree. FIG. 5 conceptually illustrates an example of the clock tree, using the chrominance prediction mode search unit 1201 as an example. More specifically, each of the process blocks including the chrominance prediction mode search unit 1201 includes a number of flip-flops for holding and storing values, and clocks are connected to all the flip-flops. Here, the number of the flip-flops connectable to a certain signal line is physically limited. Consequently, as illustrated in FIG. 5, the clocks are generally connected to the flip-flops through multistage clock buffers 501a to 501g. In the present embodiment, the group of these clock buffers and the signal lines provided among these clock buffers are called “a clock tree” in a lump. If the clock tree operates at an externally input clock frequency as it is, a large amount of power is consumed in the clock buffers and the signal lines provided among the clock buffers. Consequently, in the present embodiment, it is possible, by stopping the clock at the root of the clock tree with use of the clock control unit 151, to reduce the power to be consumed in the clock tree.

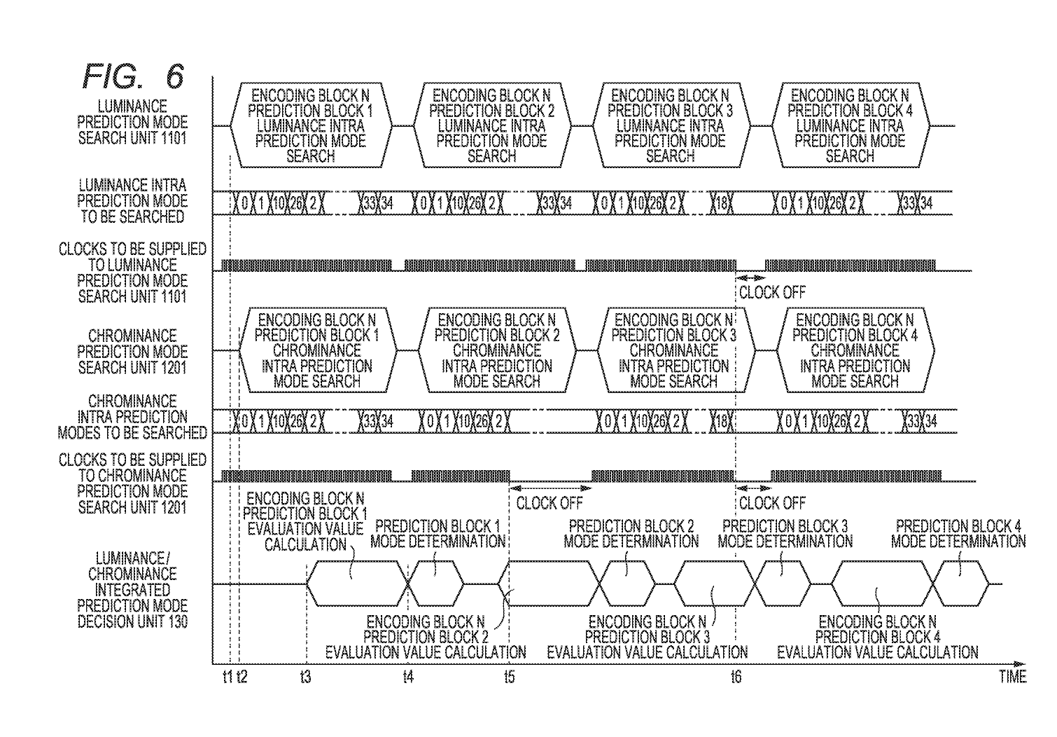

FIG. 6 illustrates an example of timing charts for chronologically showing respective operations of the luminance prediction mode search unit 1101, the chrominance prediction mode search unit 1201 and the luminance/chrominance integrated prediction mode decision unit 130 and on/off control of the clocks by the overall control unit 150 and the clock control unit 151. More specifically, FIG. 6 shows the timing charts of the processes of encoding the respective encoding blocks each having 32×32 pixels as illustrated in FIG. 2A and the state of processing the four prediction blocks each having 16×16 pixels as illustrated in FIG. 2B.

At a time t1, the luminance prediction mode search unit 1101 generates the reference luminance block corresponding to Intra_Planar (#0, indicated as “0” in FIG. 6), based on the reference luminance sample read from the luminance sample buffer 1102. Then, the luminance prediction mode search unit 1101 calculates the luminance prediction residual block which is the difference between the luminance sample of the prediction block (i.e., the prediction block 1 in FIGS. 2A and 2B) read from the block buffer 101 and the generated reference luminance block. Moreover, the luminance prediction mode search unit 1101 transfers the calculated luminance prediction residual block to the luminance/chrominance integrated prediction mode decision unit 130.

Subsequently, the luminance prediction residual blocks are likewise calculated respectively for Intra_DC (#1, indicated as “1” in FIG. 6) and Angular_{—}10 to Angular_{—}34 (#2 to #34, indicated as “2” to “34” in FIG. 6), and the calculated luminance prediction residual blocks are transferred to the luminance/chrominance integrated prediction mode decision unit 130. Here, in the first prediction block, the evaluation value IStotal[i] in which the luminance and the chrominance have been considered is not smaller than the threshold value Thtotal for any of the luminance and chrominance intra prediction modes. Consequently, the luminance prediction mode search unit 1101 performs the searching for all the modes (35 modes) being the luminance intra prediction mode candidates.

At a time t2, the chrominance prediction mode search unit 1201 generates the reference chrominance block corresponding to Intra-Planar (#0) of the Cr and Cr components, based on the reference chrominance sample read from the chrominance sample buffer 1202. Then, the chrominance prediction mode search unit 1201 calculates the chrominance prediction residual block which is the difference between the chrominance sample of the prediction target block (i.e., the prediction block 1 in FIGS. 2A and 2B) read from the block buffer 101 and the generated reference chrominance block. Moreover, the chrominance prediction mode search unit 1201 transfers the calculated chrominance prediction residual block to the luminance/chrominance integrated prediction mode decision unit 130.

Subsequently, the chrominance prediction residual blocks are likewise calculated respectively for Intra_DC (#1) and Angular_{—}10 to Angular_{—}34 (#2 to #34), and the calculated chrominance prediction residual block are transferred to the luminance/chrominance integrated prediction mode decision unit 130. Here, in the first prediction block, the chrominance component evaluation value (=IScb[i]+IScr[i]) is not smaller than the threshold value ThC for any of the chrominance intra prediction modes of the planar mode, the DC mode, the horizontal mode and the vertical mode. Moreover, as described above, the evaluation value IStotal[i] in which the luminance and the chrominance have been considered is not smaller than the threshold value Thtotal. Consequently, the chrominance prediction mode search unit 1201 performs the searching for all the modes (35 modes) being the chrominance intra prediction mode candidates.

As described above, in the first prediction block, the clock is not stopped (off) by the overall control unit 150 and the clock control unit 151 until the searching for all the luminance and chrominance intra prediction modes is completed.

Incidentally, in the present embodiment, the chrominance prediction mode search unit 1201 respectively generates the Cb-component and Cr-component chrominance prediction residual blocks for the one chrominance prediction mode candidate, and thereafter performs the searching of the next chrominance prediction mode candidate. Moreover, in the present embodiment, the input format is set to 4:2:0. In the case where the input format is 4:2:0, the number of the pixel samples of the Cb component included in the encoding block is ¼ of the number of the pixel samples of the luminance component. Consequently, it is possible to perform the prediction residual block generation process of the chrominance component at speed higher than that of the prediction residual block generation process of the luminance component.

At a time t3, since the prediction residual blocks of all the components (the luminance component, the Cb component, and the Cr component) can be used in the FIFOs 301 to 303, the luminance/chrominance integrated prediction mode decision unit 130 calculates the evaluation value of each prediction mode candidate.

At a time t4, when the evaluation values corresponding to all the prediction mode candidates are calculated, the intra prediction mode decision unit 306 determines the luminance intra prediction mode and the chrominance intra prediction mode in the manner as indicated by the flow chart of FIG. 4.

Incidentally, in the second prediction block illustrated in FIG. 6, the chrominance component evaluation value (=IScb[i]+IScr[i]) is smaller than the threshold value ThC in any of the chrominance intra prediction modes of the planar mode, the DC mode, the horizontal mode and the vertical mode. In a case like this, the operation of the chrominance prediction mode search unit 1201 is unnecessary because the chrominance intra prediction mode to be used in the generation of the encoded stream is determined. Therefore, at a time t5, the overall control unit 150 controls the clock control unit 151 to stop the clock to be supplied to the chrominance prediction mode search unit 1201. As a result, it is possible to reduce the power consumption necessary in the process of the chrominance prediction mode search unit 1201 and the power consumption in the clock tree related to the chrominance prediction mode search unit 1201, until a process of the third prediction block is started.

Moreover, in the third prediction block illustrated in FIG. 6, the evaluation value IStotal[i] corresponding to the mode 18 as the luminance intra prediction mode and the chrominance intra prediction mode is smaller than the threshold value Thtotal. In a case like this, the operations of the luminance prediction mode search unit 1101 and the chrominance prediction mode search unit 1201 are unnecessary because the luminance intra prediction mode and the chrominance intra prediction mode to be used in the generation of the encoded stream are determined. Therefore, at a time t6, the overall control unit 150 controls the clock control unit 151 to stop the clocks to be supplied to the luminance prediction mode search unit 1101 and the chrominance prediction mode search unit 1201. As a result, it is possible to reduce the power consumption necessary in the processes of the luminance prediction mode search unit 1101 and the chrominance prediction mode search unit 1201 and the power consumption in the related clock tree until a process of the fourth prediction block is started.

The above processes are performed to all the prediction blocks in the encoding block, and the process like this to the one encoding block is repeated by the number of times corresponding to the number of the encoding blocks in the screen, thereby performing the encoding to the whole screen.

As described above, in the present embodiment, the chrominance in each pixel of the prediction block is derived, according to the chrominance intra prediction mode, as the reference chrominance block from the reference chrominance sample showing the chrominance of the pixel necessary for the intra prediction. Then, the difference between the reference chrominance block and the chrominance sample of the input encoding block is derived as the chrominance prediction residual, and the evaluation value of the chrominance prediction residual (i.e., the chrominance component evaluation value=IScb[i]+IScr[i]) is derived. A process like this is performed to the candidate of the chrominance intra prediction mode adoptable irrespective of the luminance intra prediction mode. Then, the chrominance intra prediction mode corresponding to the chrominance prediction residual component evaluation value at the time when the relevant chrominance prediction residual component evaluation value is equal to or smaller than the threshold value ThC is adopted as the chrominance intra prediction mode of the prediction block. Further, at the point when the chrominance intra prediction mode is determined, the clock to be supplied to the chrominance prediction mode search unit 1201 is stopped until a process of a next prediction block is performed.

Incidentally, with respect to the luminance component, as well as the chrominance component, the luminance evaluation value ISy[i] is derived from the luminance prediction residual. Then, the evaluation value IStotal[i] which is indicated by a weighted linear sum of the chrominance evaluation values IScb[i] and IScr[i] and the luminance evaluation value ISy[i] is derived. As described above, in the case where the chrominance intra prediction mode adoptable irrespective of the luminance intra prediction mode is adopted, the weight coefficient to the chrominance evaluation values IScb[i] and IScr[i] is set to zero. On the other hand, in a case where the chrominance intra prediction mode adoptable irrespective of the luminance intra prediction mode is not adopted, the weight coefficient to the chrominance evaluation values IScb[i] and IScr[i] is set to a predetermined value other than zero. Then, the luminance intra prediction mode corresponding to the evaluation value IStotal[i] at the time when the relevant evaluation value IStotal[i] is equal to or smaller than the threshold value Thtotal is adopted, and the mode same as that relevant luminance intra prediction mode is adopted as the chrominance intra prediction mode. When the luminance intra prediction mode and the chrominance intra prediction mode are determined in this way, the clocks to be supplied to the luminance prediction mode search unit 1101 and the chrominance prediction mode search unit 1201 are stopped until a process to a next prediction block is performed.

As described above, the searching of the luminance reference mode of the chrominance prediction in which there are numerous candidates to be searched is omitted according to the comparison result of the evaluation value corresponding to the intra prediction mode and the threshold value. Therefore, it is possible to reduce the power consumption necessary for the searching of the chrominance intra prediction mode. Moreover, after the chrominance intra prediction mode was determined, it is possible, by stopping the clock to be supplied to the chrominance prediction mode search unit 1201, to reduce also the power consumption of the clock tree related to the chrominance prediction mode search unit 1201.

In the present embodiment, the on/off control of the clocks is used as the method for reducing the power consumption. However, the present invention is not limited to this. For example, it is possible to further reduce the power consumption by turning off a power supply or reducing voltage during a period that the clock is off.

Moreover, it is determined based on the comparison result of the evaluation value and the threshold value whether or not to omit the searching of the chrominance intra prediction mode and the luminance intra prediction mode (see the steps S405 and 410). Therefore, only in a case where a generated code amount is sufficiently small even if searching of a subsequent prediction mode is omitted, the searching in the luminance intra prediction and the chrominance intra prediction is omitted. Consequently, it is possible, even if the power consumption is reduced, to minimize an increase in the code amount. An effect obtained by reducing the power consumption and the increase in the code amount are in a trade-off relation, and it is possible for the user of the image encoding apparatus 100 to set the threshold value in the step S403 according to a use case. Namely, if the threshold value is reduced, the effect obtained by reducing the power consumption becomes small, but it is possible to reduce the code amount. On the contrary, if the threshold value is increased, the code amount is increased, but the effect obtained by reducing the power consumption becomes large.

Incidentally, in the present embodiment, the algorithm for evaluating all the candidates of the intra prediction mode is used. However, the present invention is not limited to this. That is, even if an algorithm for searching for the intra prediction mode while omitting the evaluation of a part of the candidates of the intra prediction mode is adopted for the purpose of a high-speed process, it is possible to apply the method same as that described in the present embodiment. Moreover, the order of searching for the candidates of each intra prediction mode is not limited to the above-described order. Namely, it is possible to perform the searching in any order.

Moreover, in the present embodiment, the format of 4:2:0 is used as the input format. However, the input format is not limited to this. That is, the input format does not depend on a ratio between the number of pixel samples of the luminance component (i.e., a luminance sample number) and the number of samples of the chrominance component (i.e., a chrominance sample number), and it is possible to carry out the present embodiment in any of generally used formats 4:2:0, 4:2:2 and 4:4:4.

Moreover, in the present embodiment, only the I slice in which the encoding is performed using the intra prediction is considered as the encoding target but the P slice and the B slice in which the encoding is performed using the inter-screen prediction with the motion vectors are not considered as the encoding target. However, the present invention is not limited to this. That is, as described in a later-described second embodiment, it is possible to apply the method of the present embodiment to encode an encoding block using the intra prediction in the P slice or the B slice.

Moreover, in the present embodiment, it is determined whether or not the chrominance component evaluation value (=IScb[i]+IScr[i]) is equal to or smaller than the threshold value ThC, and it is also determined whether or not the evaluation value IStotal[i] is equal to or smaller than the threshold value. However, the above determination need not necessarily be performed if it has been determined whether or not the above evaluation values satisfy a predetermined condition which indicates that the estimated generated code amount of the prediction residual block is small. For example, it is possible to determine whether or not the chrominance component evaluation value (=IScb[i]+IScr[i]) is smaller than the threshold value and also to determine whether or not the evaluation value IStotal[i] is smaller than the threshold value.

Incidentally, in the present embodiment, it is unnecessary to perform the process strictly per the encoding block. That is, even if the encoding is replaced by a prediction block corresponding to the encoding block in the description of the present embodiment, the main purport of the present embodiment is not different.

### Second Embodiment

Subsequently, the second embodiment of the present invention will be described. In the first embodiment, each block premises that only the I slice in which the encoding is performed using only the intra prediction is used. On the other hand, in the present embodiment, an image encoding apparatus which performs encoding by, in addition to the I slice, the P slice or the B slice in which each prediction block of the encoding block is encoded using the inter-screen prediction for performing motion compensation with motion vectors will be described. As just described, the present embodiment is different from the first embodiment mainly in parts of the constitutions and the processes because the encoding target in the present embodiment is different from that in the first embodiment. Therefore, in the present embodiment, the portions same as those in the first embodiment are added with the corresponding identical numerals and symbols as described in FIGS. 1 to 6 and detailed descriptions of these portions will be omitted.

In the present embodiment, as well as the first embodiment, it is assumed that one or more input images are divided into encoding blocks each having 32×32 pixels and encoding is performed with respect to each of the encoding blocks. Further, it is assumed that the size of the prediction block of the luminance component is 16×16 pixels and the size of the prediction block of the chrominance component is 8×8 pixels.

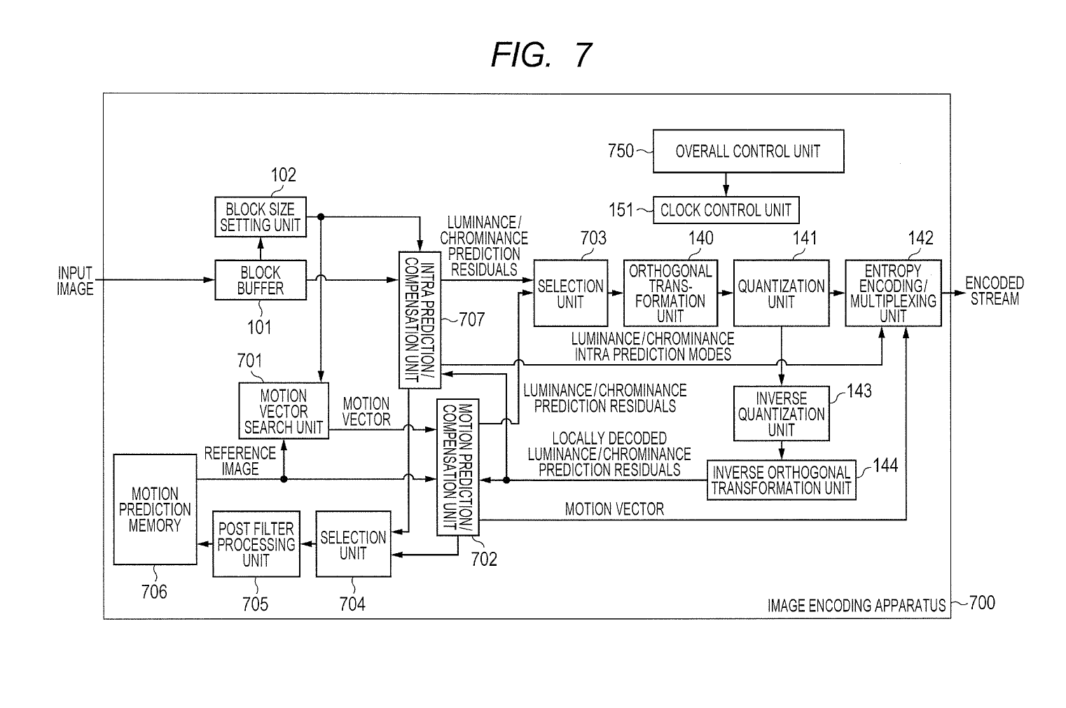

FIG. 7 is a block diagram illustrating an example of the constitution of an image encoding apparatus 700 according to the present embodiment.

An intra prediction/compensation unit 707 is a process block which is constituted by the luminance prediction mode search unit 1101, the chrominance prediction mode search unit 1201 and the luminance/chrominance integrated prediction mode decision unit 130 respectively illustrated in FIG. 1, and the operations of these units are substantially the same as those described in the first embodiment.

A motion vector search unit 701 calculates a candidate of a motion vector determined by a predetermined motion vector search algorithm. One motion vector is defined to the prediction block of the luminance component having 16×16 pixels, and to the prediction block of the chrominance component having 8×8 pixels. When the reconstituted luminance sample corresponding to the candidate of the motion vector is input from a motion prediction memory 706, the motion vector search unit 701 generates the reference luminance block of 16×16 pixels being the size of the prediction block.

Moreover, the motion vector search unit 701 reads the luminance sample of the input image of 16×16 pixels from the block buffer 101, and calculates the prediction residual block of the luminance sample based on the read luminance sample and the reference luminance block. The evaluation value corresponding to the motion vector is calculated from the prediction residual block of the reference sample. Here, as a method of calculating the evaluation value, it is possible to use any calculation method such as a method of obtaining the SAD described in the first embodiment. The motion vector search unit 701 calculates the evaluation values for all the motion vector candidates corresponding to the motion vector search algorithm, determines the motion vector candidate of which the evaluation value is most desirable as the motion vector to be used in the encoding, and transfers the determined motion vector to a motion prediction/compensation unit 702.

The motion prediction/compensation unit 702 reads, from the motion prediction memory 706, the reconstituted luminance sample and the reconstituted chrominance sample by using the motion vector determined by the motion vector search unit 701. Then, the motion prediction/compensation unit 702 generates the reference luminance block of 16×16 pixels and the reference chrominance block of 8×8 pixels. Moreover, the motion prediction/compensation unit 702 calculates the prediction residual block of the reference luminance block and the luminance sample of the input image from the block buffer 101, and the prediction residual block of the reference chrominance block and the chrominance sample of the input image from the block buffer 101.

The motion prediction/compensation unit 702 generates an evaluation value in case of using motion compensation, from the luminance prediction residual block and the chrominance prediction residual block. Moreover, the motion prediction/compensation unit 702 transfers the motion vector to the entropy encoding/multiplexing unit 142 to multiplex the motion vector to the entropy encoding and the encoded stream.

An overall control unit 750 respectively reads, from the intra prediction/compensation unit 707 and the motion prediction/compensation unit 702, the evaluation values in which the luminance and the chrominance have been considered respectively, and then compares these evaluation values with each other. Subsequently, the overall control unit 750 determines, based on the compared result, by which of the intra-screen prediction and the inter-screen prediction the prediction block should be encoded, and then outputs a selection signal to selection units 703 and 704.

The selection unit 703 selects the luminance prediction residual block and the chrominance prediction residual block of either one of the intra prediction/compensation unit 707 and the motion prediction/compensation unit 702, in response to the selection signal output from the overall control unit 750, and then outputs the selected blocks to the orthogonal transformation unit 140.

The motion prediction/compensation unit 702 adds the reference block used in the motion compensation to the decoded prediction residual output from the inverse orthogonal transformation unit 144, and then outputs the obtained data as the locally decoded reconstituted image block to the selection unit 704.

The selection unit 704 selects the reconstituted image block on the basis of the selection signal for the process-target prediction block output from the overall control unit 750, and then outputs the selected block to a post filter processing unit 705. That is, when the process-target prediction block is subjected to the intra-screen encoding, the reconstituted image blocks of luminance and the chrominance respectively generated by the luminance intra prediction compensation unit 1103 and the chrominance intra prediction compensation unit 1203 both illustrated in FIG. 1 are output to the post filter processing unit 705. On the other hand, when the process-target prediction block is subjected to the inter-screen encoding, the reconstituted image blocks of the luminance and the chrominance generated by the motion prediction/compensation unit 702 are output to the post filter processing unit 705.

The post filter processing unit 705 performs a filter process such as a deblocking filter process or the like to the reconstituted image block of the process-target prediction block to reduce deterioration of image quality, and then records the processed block in the motion prediction memory 706. The reconstituted image block recorded in the motion prediction memory 706 is used in case of generating a reference block for the inter-screen prediction for a subsequent image.

Also in the P slice or the B slice in the HEVC, there is a possibility that each block is encoded using the intra prediction. The calculation of the evaluation values of the luminance intra prediction mode and the chrominance intra prediction mode of each encoding block by the intra prediction/compensation unit 707 is performed with respect to all the encoding blocks. Consequently, as well as the first embodiment, it is possible in the present embodiment to reduce the power consumption by omitting the searching of the intra prediction mode and performing the clock control with the overall control unit 750 and the clock control unit 151.

Moreover, in a case where the evaluation values by the luminance intra prediction and the chrominance intra prediction are smaller than the threshold value as a result of the process by the intra prediction/compensation unit 707 and thus sufficient encoding efficiency can be achieved only by the intra prediction, it is possible to further reduce the power consumption. That is, it is determined, by performing the process of the intra prediction/compensation unit 707 before the process of the motion prediction/compensation unit 702, whether or not the evaluation values by the luminance intra prediction and the chrominance intra prediction are smaller than the threshold value. Then, if the evaluation values are smaller than the threshold value and it is determined to perform the intra prediction for the relevant prediction block, the process of the motion prediction/compensation unit 702 is not performed, and the clocks to be supplied to the motion prediction/compensation unit 702 by the overall control unit 750 and the clock control unit 151 are stopped. In this case, since the power consumption by the process of the motion prediction/compensation unit 702 and the power consumption of the clock tree are reduced, it is possible to have a greater reduction effect of the power consumption.

As just described, it is possible to easily incorporate the algorithm for the intra prediction described in the first embodiment into the image encoding apparatus which uses both the intra-screen prediction encoding and the inter-screen prediction encoding. Moreover, the process described in the present embodiment does not depend on a specific motion vector search algorithm, and apply any kind of generally used motion vector search algorithm can be applied.

Moreover, as well as the first embodiment, the method for reducing the power consumption is not limited to the on/off control of the clocks. More specifically, it is possible to further reduce the power consumption by turning off a power supply or reducing voltage during a period that the clock is off.

Incidentally, the above embodiments merely indicate the examples of concretization in case of carrying out the present invention, and it should be understood that, by the above embodiments, the technical scope of the present invention should not be interpreted in a limited way. That is, many apparently widely different embodiments of the present invention can be made without departing from the scope and principal features thereof.

### Other Embodiments

The embodiments of the present invention can also be realized by a computer of a system or an apparatus that reads out and executes computer executable instructions recorded on a storage medium (e.g., a non-transitory computer-readable storage medium) to perform the functions of one or more of the above-described embodiments of the present invention, and by a method performed by the computer of the system or the apparatus by, for example, reading out and executing the computer executable instructions from the storage medium to perform the functions of one or more of the above-described embodiments. The computer may comprise one or more of a CPU (central processing unit), MPU (micro processing unit), or other circuitry, and may include a network of separate computers or separate computer processors. The computer executable instructions may be provided to the computer, for example, from a network or the storage medium. The storage medium may include, for example, one or more of a hard disc, a RAM (random-access memory), a ROM (read only memory), a storage of distributed computing systems, an optical disc (such as a CD (compact disc), a DVD (digital versatile disc), or a BD™ (Blue-ray Disc)), a flash memory device, a memory card, and the like.

While the present invention has been described with reference to the exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-282823, filed Dec. 26, 2012, which is hereby incorporated by reference herein in its entirety.

What is claimed is:

1. An image encoding apparatus which compresses an input image with respect to each encoding block and outputs an encoded stream, comprising:
a first intra-screen prediction unit configured to, with respect to a plurality of candidates of a first prediction mode, derive a first prediction residual block which is a difference between a value of a first image component of a block obtained by performing intra-screen prediction to the first image component in the first prediction mode and a value of the first image component in a block obtained from the first image component of the input image, per a prediction block corresponding to the encoding block or a plurality of prediction blocks obtained by dividing the encoding block;
a second intra-screen prediction unit configured to, with respect to a plurality of candidates of a second prediction mode, derive a second prediction residual block which is a difference between a value of a second image component of a block obtained by performing intra-screen prediction to the second image component in the second prediction mode and a value of the second image component in a block obtained from the second image component of the input image, per the prediction block corresponding to the encoding block or the plurality of prediction blocks obtained by dividing the encoding block; and
a prediction mode determination unit configured to determine the second prediction mode to be used in the intra-screen prediction for the second image component of the input image, on the basis of an evaluation value representing an estimated generated code amount of the second prediction residual block obtained for the candidate of the second prediction mode,
wherein, in a case where the evaluation value representing the estimated generated code amount of the second prediction residual block for the candidate of a specific second prediction mode among the candidates of the second prediction mode satisfies a predetermined condition, the prediction mode determination unit determines the candidate of the specific second prediction mode at a time when the evaluation value satisfying the predetermined condition is obtained, as the second prediction mode to be used in the intra-screen prediction for the second image component of the input image.

2. The image encoding apparatus according to claim 1, further comprising a clock control unit configured to control at least a clock to be supplied to the first intra-screen prediction unit and a clock to be supplied to the second intra-screen prediction unit,
wherein the second intra-screen prediction unit operates when the clock is input, but does not operate when the clock is not input, and
wherein, in the case where the evaluation value representing the estimated generated code amount of the second prediction residual block for the candidate of the specific second prediction mode among the candidates of the second prediction mode satisfies the predetermined condition, the clock control unit stops the clock to be supplied to the second intra-screen prediction unit until an operation for a next prediction block is started.

3. The image encoding apparatus according to claim 1,
wherein the second prediction mode includes a prediction mode which is determined according to the first prediction mode, and a prediction mode which is determined irrespective of the first prediction mode,
wherein the second intra-screen prediction unit derives the second prediction residual block for a candidate of the prediction mode which is determined irrespective of the first prediction mode before the second prediction residual block for a candidate of the prediction mode which is determined according to the first prediction mode, and
wherein, in the case where the evaluation value representing the estimated generated code amount of the second prediction residual block for the candidate of the prediction mode which is determined irrespective of the first prediction mode satisfies the predetermined condition, the prediction mode determination unit determines the candidate of the prediction mode at a time when the evaluation value satisfying the predetermined condition is obtained, as the second prediction mode to be used in the intra-screen prediction for the second image component of the input image.

4. The image encoding apparatus according to claim 3,
wherein the prediction mode determination unit determines the first prediction mode to be used in the intra-screen prediction for the first image component of the input image, based on whether or not an evaluation value which is represented by a weighted linear sum of an evaluation value representing an estimated generated code amount of the first prediction residual block obtained for the candidate of the first prediction mode and the evaluation value representing the estimated generated code amount of the second prediction residual block obtained for the candidate of the second prediction mode satisfies a predetermined condition, and
wherein, in a case where the candidate of the specific second prediction mode is determined as the second prediction mode to be used in the intra-screen prediction for the second image component of the input image, the prediction mode determination unit sets a weight to the evaluation value representing the estimated generated code amount of the second prediction residual block to zero.

5. The image encoding apparatus according to claim 1, wherein, in a case where the evaluation value representing the estimated generated code amount of the second prediction residual block for the candidate of the specific second prediction mode does not satisfy the predetermined condition, the prediction mode determination unit determines the first prediction mode and the second prediction mode so that the first prediction mode to be used in the intra-screen prediction for the first image component of the input image and the second prediction mode to be used in the intra-screen prediction for the second image component of the input image become the same prediction mode.

6. The image encoding apparatus according to claim 1, wherein the specific second prediction mode includes one or more prediction modes of a horizontal mode, a vertical mode, a DC mode and a planar mode in HEVC (High Efficiency Video Coding).

7. The image encoding apparatus according to claim 1, wherein, in a case where the minimum evaluation value among the evaluation values representing the estimated generated code amounts of the second prediction residual block for the candidate of the specific second prediction mode is smaller than a threshold value, the prediction mode determination unit determines the candidate of the specific second prediction mode at a time when the minimum evaluation value is obtained, as the second prediction mode to be used in the intra-screen prediction for the second image component of the input image.

8. An image encoding method which compresses an input image with respect to each encoding block and outputs an encoded stream, comprising:
a first intra-screen prediction step of, with respect to a plurality of candidates of a first prediction mode, deriving a first prediction residual block which is a difference between a value of a first image component of a block obtained by performing intra-screen prediction to the first image component in the first prediction mode and a value of the first image component in a block obtained from the first image component of the input image, per a prediction block corresponding to the encoding block or a plurality of prediction blocks obtained by dividing the encoding block;
a second intra-screen prediction step of, with respect to a plurality of candidates of a second prediction mode, deriving a second prediction residual block which is a difference between a value of a second image component of a block obtained by performing intra-screen prediction to the second image component in the second prediction mode and a value of the second image component in a block obtained from the second image component of the input image, per the prediction block corresponding to the encoding block or the plurality of prediction blocks obtained by dividing the encoding block; and
a prediction mode determination step of determining the second prediction mode to be used in the intra-screen prediction for the second image component of the input image, on the basis of an evaluation value representing an estimated generated code amount of the second prediction residual block obtained for the candidate of the second prediction mode,
wherein, in a case where the evaluation value representing the estimated generated code amount of the second prediction residual block for the candidate of a specific second prediction mode among the candidates of the second prediction mode satisfies a predetermined condition, the prediction mode determination step determines the candidate of the specific second prediction mode at a time when the evaluation value satisfying the predetermined condition is obtained, as the second prediction mode to be used in the intra-screen prediction for the second image component of the input image.

9. The image encoding method according to claim 8, further comprising a clock control step of controlling at least a clock to be supplied in the first intra-screen prediction step and a clock to be supplied in the second intra-screen prediction step,
wherein the second intra-screen prediction step operates when the clock is input, but does not operate when the clock is not input, and
wherein, in the case where the evaluation value representing the estimated generated code amount of the second prediction residual block for the candidate of the specific second prediction mode among the candidates of the second prediction mode satisfies the predetermined condition, the clock control step stops the clock to be supplied in the second intra-screen prediction step until an operation for a next prediction block is started.

10. The image encoding method according to claim 8,
wherein the second prediction mode includes a prediction mode which is determined according to the first prediction mode, and a prediction mode which is determined irrespective of the first prediction mode,
wherein the second intra-screen prediction step derives the second prediction residual block for a candidate of the prediction mode which is determined irrespective of the first prediction mode before the second prediction residual block for a candidate of the prediction mode which is determined according to the first prediction mode, and
wherein, in the case where the evaluation value representing the estimated generated code amount of the second prediction residual block for the candidate of the prediction mode which is determined irrespective of the first prediction mode satisfies the predetermined condition, the prediction mode determination step determines the candidate of the prediction mode at a time when the evaluation value satisfying the predetermined condition is obtained, as the second prediction mode to be used in the intra-screen prediction for the second image component of the input image.

11. The image encoding method according to claim 10,
wherein the prediction mode determination step determines the first prediction mode to be used in the intra-screen prediction for the first image component of the input image, based on whether or not an evaluation value which is represented by a weighted linear sum of an evaluation value representing an estimated generated code amount of the first prediction residual block obtained for the candidate of the first prediction mode and the evaluation value representing the estimated generated code amount of the second prediction residual block obtained for the candidate of the second prediction mode satisfies a predetermined condition, and
wherein, in a case where the candidate of the specific second prediction mode is determined as the second prediction mode to be used in the intra-screen prediction for the second image component of the input image, the prediction mode determination step sets a weight to the evaluation value representing the estimated generated code amount of the second prediction residual block to zero.

12. The image encoding method according to claim 8, wherein, in a case where the evaluation value representing the estimated generated code amount of the second prediction residual block for the candidate of the specific second prediction mode does not satisfy the predetermined condition, the prediction mode determination step determines the first prediction mode and the second prediction mode so that the first prediction mode to be used in the intra-screen prediction for the first image component of the input image and the second prediction mode to be used in the intra-screen prediction for the second image component of the input image become the same prediction mode.

13. The image encoding method according to claim 8, wherein the specific second prediction mode includes one or more prediction modes of a horizontal mode, a vertical mode, a DC mode and a planar mode in HEVC.

14. The image encoding method according to claim 8, wherein, in a case where the minimum evaluation value among the evaluation values representing the estimated generated code amounts of the second prediction residual block for the candidate of the specific second prediction mode is smaller than a threshold value, the prediction mode determination step determines the candidate of the specific second prediction mode at a time when the minimum evaluation value is obtained, as the second prediction mode to be used in the intra-screen prediction for the second image component of the input image.

15. A computer program for causing a computer to perform the respective steps in the image encoding method described in claim 8.
